(19) United States
(12) Patent Application Publication
(10) Pub. No.: US 2008/0182073 A1
(43) Pub. Date: Jul. 31, 2008

(54) MANUFACTURING METHOD OF AN ARTIFICIAL STRIP FOR IMITATIVE RATTAN/WILLOW FURNITURE AND THE ARTIFICIAL STRIP THEREOF

(76) Inventor: Wei-Sung Chen, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/669,514

(22) Filed: Jan. 31, 2007

(51) Int. Cl. B32B 3/10; C08F 110/00

(52) U.S. Cl. 428/155; 521/143

(57) ABSTRACT

A manufacturing method of an artificial strip for imitative rattan/willow furniture is to mix unicolor or multicolor polyethylene (PE) with a catalyst that makes the mixture foam after heating. Then, the mixture is extruded via special shaped opening on a shaping mold to perform the artificial strip with chap and crank patterns. Moreover, the color distribution on the artificial strip can be performed evenly or unevenly to create more versatile appearance. Thereby, the artificial strip has a verisimilitude texture approximately like the natural willow or rattan strips to make the manufactured imitative rattan/willow furniture have excellent appearance.

### BACKGROUND OF THE INVENTION

1. Field of the Invention

The present invention relates to a manufacturing method of an artificial strip for imitative rattan/willow furniture, and more particularly to a manufacturing method that makes the artificial strip and furniture (table or chair, etc.) constructed by the artificial strip have vivid appearance when being arranged outdoor and have improved texture touch feeling so that market value of the relative products is greatly improved.

2. Description of Related Art

Natural rattan/willow strips is an important material for manufacturing furniture, baskets, boxes and other household objects. However, the household objects made of natural rattan/willow strips is not suitable for outdoor usage because the rattan/willow strips become soft and weaken after damping and even get rotten or moldy. Conventionally, the natural rattan/willow strips need to be processed by manpower before manufacturing the objects and then sopped into water until softening. Then, the natural rattan/willow strips enable to be shaped and alternatively waved in transversal and longitudinal directions on a corresponding frame to construct the household objects. However, after the natural-style furniture becomes popular, price of the natural rattan/willow strip is steadily and tremendously increased because of source shortage.

In order to avoid the usage and shortage problems and of the conventional natural rattan/willow strips, furniture manufacturers all work on finding a new material to substitute the natural rattan/willow strips.

### SUMMARY OF THE INVENTION

To overcome the drawbacks of the conventional problems in manufacturing imitative rattan or willow furniture, an improved manufacturing method is provided to eliminate the drawbacks.

A main objective of the present invention is to provide a manufacturing method that produces an artificial strip having a chap or crack patterns on periphery to imitate natural rattan/willow strips for manufacturing furniture.

Another main objective of the present invention is to provide an artificial strip made by the foregoing manufacturing method and having vivid appearance.

To achieve the foregoing objectives, the manufacturing method of an artificial strip for imitative rattan or willow furniture is to mix a first polyethylene material with a first catalyst to perform a first mixture, heat the first mixture to foam and extrude via a first opening on a shaping mold to achieve a first artificial strip with chap and crack pattern on periphery. Selectively, the manufacturing method is further to prepare a second polyethylene material with different color to be foamed and processed in the same means to produce a second artificial strip to combine with the first artificial strip.

To achieve the foregoing objectives, the artificial strip comprising an elongated body with chap and crack patterns on periphery, wherein the chap and crack patterns are produced by foaming.

By the manufacturing method described above, the artificial strip has a verisimilitude texture approximately like the natural willow or rattan strip to make the manufactured imitative rattan/willow furniture have excellent vivid appearance.

Further benefits and advantages of the present invention will become apparent after a careful reading of the detailed description with appropriate reference to the accompanying drawings.

### BRIEF DESCRIPTION OF THE DRAWINGS

FIG. 1 is a schematic proceeding blocks of a first embodiment of a manufacturing method of an artificial strip having single color in accordance with the present invention;

FIG. 2 is a schematic proceeding blocks of a second embodiment of the manufacturing method of the artificial strip having two colors in accordance with the present invention;

FIG. 3 is a perspective view of a first embodiment of the artificial strip having a single color by the manufacturing method in FIG. 1;

FIG. 4 is a perspective view of a second embodiment of the artificial strip having a single color by the manufacturing method in FIG. 1;

FIG. 5 is a perspective view of a third embodiment of the artificial strip having a single color by the manufacturing method in FIG. 1;

FIG. 6 is a perspective view of a first embodiment of the artificial strip having two colors by the manufacturing method in FIG. 2;

FIG. 7 is a perspective view of a second embodiment of the artificial strip having two colors by the manufacturing method in FIG. 2; and

FIG. 8 is a perspective view of a third embodiment of the artificial strip having two colors by the manufacturing method in FIG. 2.

### DETAILED DESCRIPTION OF THE PREFERRED EMBODIMENT

A manufacturing method of an artificial strip for imitative rattan/willow furniture in accordance with the present invention is to mix unicolor or multicolor polyethylene (PE) with a catalyst that makes the mixture foam after heating. Then, the mixture is extruded via special shaped opening on a shaping mold to perform the artificial strip with chap and crank patterns. Moreover, the color distribution on the artificial strip can be performed evenly or unevenly to create more various appearance. Thereby, the artificial strip has a verisimilitude texture approximately like the natural willow or rattan strips to make the manufactured imitative rattan or willow furniture have excellent appearance.

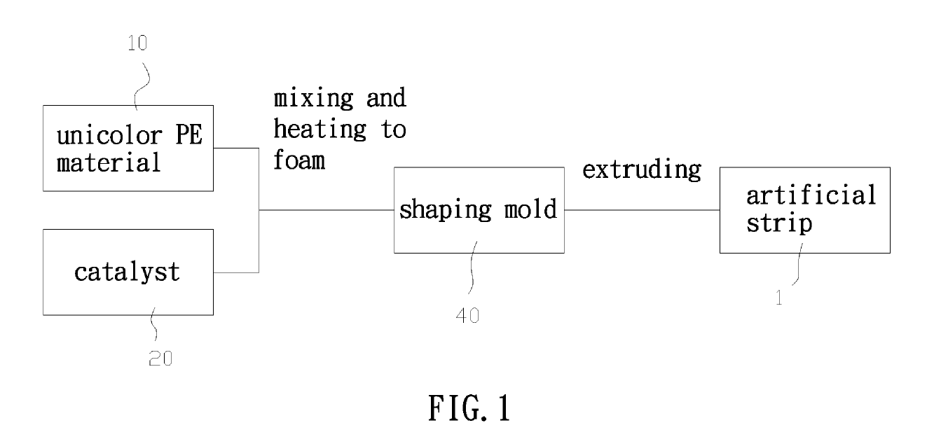

With reference to FIG. 1, a first preferred embodiment of the manufacturing method of an artificial strip is to mix a unicolor polyethylene material 10 with a catalyst 20 to compose a mixture. Then, the mixture is heated to foam and extruded via a special shaped opening on a shaping mold 40 to achieve the artificial strip 1 with chap and crack patterns on periphery.

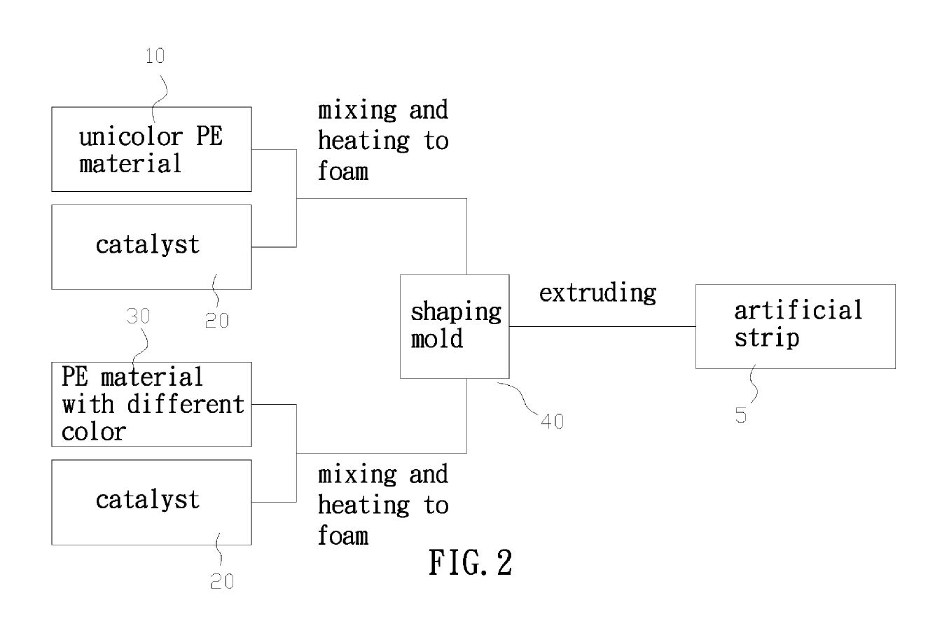

In a second preferred embodiment of the manufacturing method as shown in FIG. 2, two polyethylene materials with different colors 10, 30 can be prepared, mixed with the catalysts 20, heated to foam, and extruded via same or two special shaped openings on same or different shaping molds 40. Thereby, the achieved artificial strips 5 have multicolor appearance and even or uneven color distribution thereon to increase versatility.

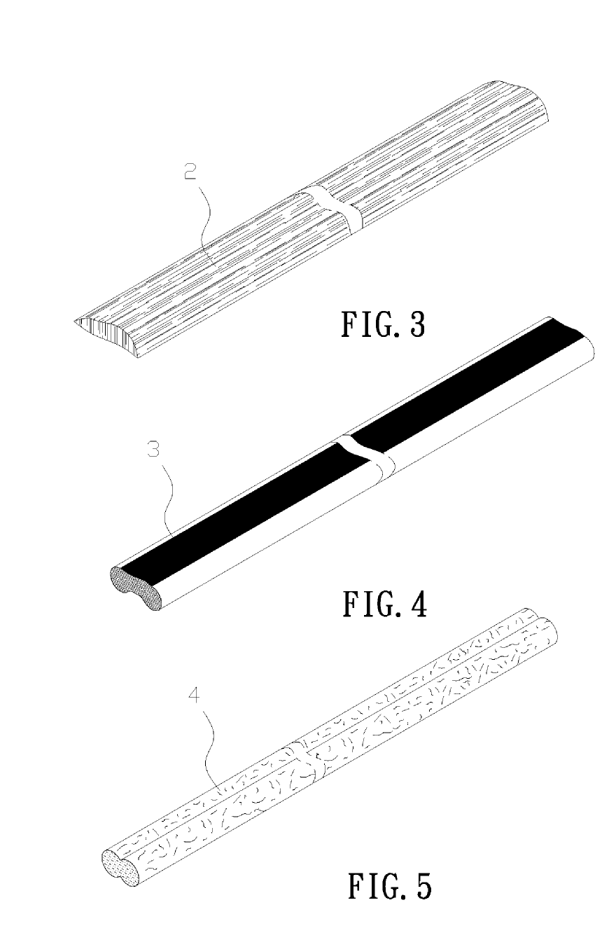

As shown in FIG. 3, the artificial strip 2 is manufactured by the first embodiment of the manufacturing method and is a unicolor one having a flatten cross-section and with a rough surface just like a stripped rattan strip.

As shown in FIG. 4, the artificial strip 3 is manufactured by the first embodiment of the manufacturing method and is a unicolor one having a flatten cross-section with a dotted surface. Particularly, the artificial strip in FIG. 4 has a central dark zone longitudinally formed on one side and a groove (not numbered) longitudinally formed on the other side.

As shown in FIG. 5, the artificial strip 4 is manufactured by the first embodiment of the manufacturing method and is a unicolor one having a cross-section with two round parts partially overlapping with each other. The artificial strip in FIG. 5 also has chapped and crack appearance just like a natural rattan or willow strip.

As shown in FIG. 6, the artificial strip 6 is manufactured by the second embodiment of the manufacturing method and is a multicolor one with three strings twisted with each other.

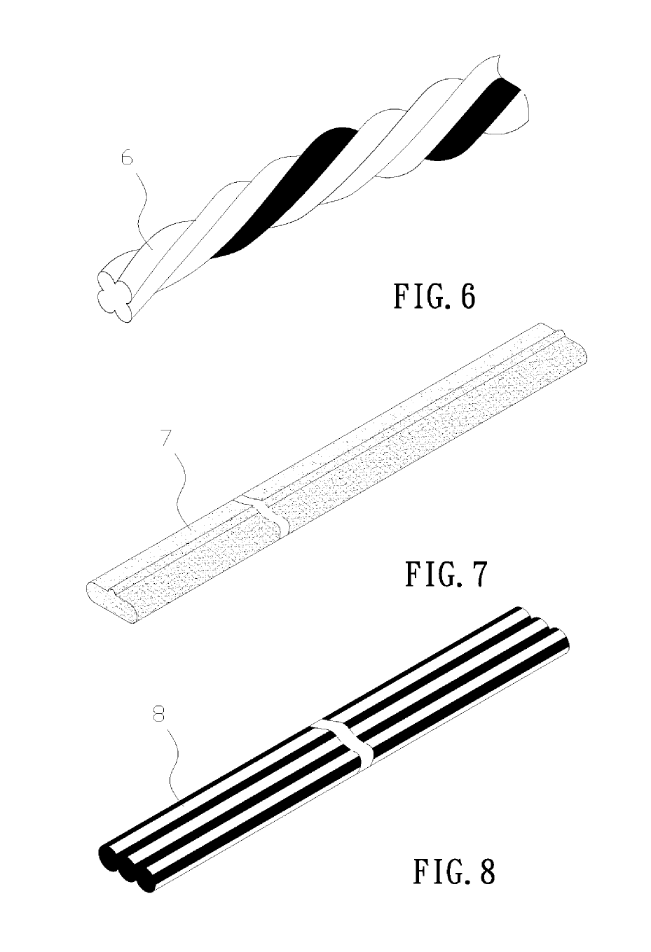

As shown in FIG. 7, the artificial strip 7 is manufactured by the second embodiment of the manufacturing method and is a multicolor one having a flatten cross-section and a rough surface with different color tones. Particularly, the artificial strip 7 has a rib longitudinally formed on one side thereon.

As shown in FIG. 8, the artificial strip 8 is manufactured by the second embodiment of the manufacturing method and is a multicolor one having a cross-section with three round parts partially overlapping with each other in line. The artificial strip in FIG. 8 also has a crack surface and multiple dark elongated zones longitudinally formed thereon.

According to above description, the manufacturing method and the artificial strip made thereby have the following advantages:

1. Because the artificial strip is made of polyester plastic material, the imitative rattan/willow furniture does not easily become rotten or moldy even in an outdoor humid environment.

2. By the manufacturing methods described above, the artificial strip has chap and crack patterns and a verisimilitude texture approximately like the natural willow or rattan strips to make the manufactured imitative rattan/willow furniture have excellent appearance.

3. When the artificial strip is multicolor, variation is correspondingly increased.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A manufacturing method of an artificial strip for imitative rattan/willow furniture is to mix a first polyethylene material with a first catalyst to perform a first mixture, heat the first mixture to foam and extrude via a first opening on a shaping mold to achieve a first artificial strip with chap and crack pattern on periphery.

2. The manufacturing method as claimed in claim 1, wherein the first polyethylene material is unicolor.

3. The manufacturing method as claimed in claim 1, wherein the first polyethylene material is multicolor.

4. The manufacturing method as claimed in claim 1, wherein the manufacturing method further is to additionally mix a second polyethylene material with a second catalyst to perform a second mixture, heat the second mixture to foam and extrud via a second opening on a second shaping mold to achieve a second artificial strip with chap and crack pattern on periphery; then, the first and second artificial strips are longitudinally combined together.

5. The manufacturing method as claimed in claim 4, wherein the first and second artificial strips are twisted to combine with each other.

6. The manufacturing method as claimed in claim 4, wherein the first and second polyethylene materials are unicolor.

7. The manufacturing method as claimed in claim 4, wherein the first and second polyethylene materials are multicolor.

8. An artificial strip comprising an elongated body with chap and crack patterns on periphery, wherein the chap and crack patterns are produced by foaming.

9. The artificial strip as claimed in claim 8, wherein the artificial strip is a unicolor one having a flatten cross-section and with a rough surface just like a stripped rattan strip.

10. The artificial strip as claimed in claim 8, wherein the artificial strip is a unicolor one having a flatten cross-section with a dotted surface and has a central dark zone longitudinally formed on one side and a groove longitudinally formed on the other side.

11. The artificial strip as claimed in claim 8, wherein the artificial strip is a unicolor one having a cross-section with two round parts partially overlapping with each other.

12. The artificial strip as claimed in claim 8, wherein the artificial strip is a multicolor one having a flatten cross-section and a rough surface with different color tones and has a rib longitudinally formed on one side thereon.

13. The artificial strip as claimed in claim 8, wherein the artificial strip is a multicolor one having a cross-section with three round parts partially overlapping with each other in line and has multiple dark elongated zones longitudinally formed on the periphery.

14. The artificial strip as claimed in claim 8, wherein the artificial strip is a multicolor one and is composed of three strings twisted together.
